(19) United States
(12) Patent Application Publication
(10) Pub. No.: US 2004/0061663 A1
(43) Pub. Date: Apr. 1, 2004

(54) Virtual reality display apparatus and associated display mounting system

(75) Inventors: Michael H. Reynolds, Stuart, FL (US); H. Lee Martin, Knoxville, TN (US)

Correspondence Address: PITTS AND BRITTIAN P C, P O BOX 51295, KNOXVILLE, TN, 37950-1295, US

(73) Assignee: CyberEyes, Inc., Knoxville, TN (US)

(21) Appl. No.: 10/256,488

(22) Filed: Sep. 27, 2002

(51) Int. Cl. G09G 5/00

(52) U.S. Cl. 345/8

(57) ABSTRACT

A virtual reality display apparatus (10) for generating virtual reality images to be viewed by a user, and an associated display mounting system (12). The virtual reality display apparatus (10) includes an image generating system (14) for generating virtual reality images, the image generating system including first and second video display units (20, 22) for transmitting video images to the eyes of the user. The display mounting system (12) is secured on the head of the user and supports the first and second video display units (20, 22) in a position such that the virtual reality images can be view by the user. The display mounting system (12) includes a frame (42) defining a perimeter for surrounding the eyes of the user, and a gasket (46) secured to the perimeter of the frame (42) for engaging the face of the user, the gasket (46) being fabricated of a resilient material for cushioning the engagement of the display mounting system (12) with the face of the user, and whereby the gasket (46) deforms upon engagement with the face of the user to seal the engagement of the display mounting system (12) with the face of the user and substantially occludes the transmission of ambient light between the frame (42) and the face of the user. The display mounting system (12) further includes a support panel (52) secured to the frame (42) for supporting the image generating system (14).

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention relates to virtual reality display devices for generating virtual reality images to be viewed by a user, and relates to mounting systems for mounting virtual reality image generating devices on the head of the user.

2. Description of the Related Art

Various virtual reality display systems, including head mounted display systems, are known. However, head mounted display systems have typically been large and heavy mechanisms which are uncomfortable to wear. Helmet mounted displays with movable visors that hold the image elements, such as the system shown in U.S. Pat. No. 5,373,857, have been designed, but helmet mounted displays tend to be bulky and uncomfortable to wear with the helmet structure adding significant weight to the overall device. More compact head mounted display systems are known to employ rigid frames similar to a pair of glasses such as the device shown in U.S. Pat. No. 5,162,828. This type of design can significantly reduce the weight of the display device when compared to the helmet mounted design, but these systems typically place most of the weight of the system on the bridge of the nose causing discomfort to the user over time. Moreover, this type of head mounted display allows significant amounts of ambient light to enter the users eye. This ambient light can not only degrade the video image displayed to the user, but can be a distraction to the user, thereby detracting from the overall experience of the virtual environment. Whereas shrouds and flexible panels have been used to occlude ambient light, the use of such mechanisms tends to add to the bulk and weight of the overall display system, and can otherwise increase the discomfort of wearing the system. Various virtual reality imaging systems, and head-mounted display systems, are disclosed in the following U.S. Patents: U.S. Pat. No. 5,737,505 issued to Shaw et al. on Apr. 7, 1998; U.S. Pat. No. 5,782,639 issued to Beal on Jul. 21, 1998; U.S. Pat. No. 5,844,530 issued to Tosaki on Dec. 1, 1998; U.S. Pat. No. 5,846,134 issued to Latypov on Dec. 8, 1998; U.S. Pat. No. 6,064,355 issued to Donahue et al. on May 16, 2000; U.S. Pat. No. 6,102,832 issued to Tani on Aug. 15, 2000; U.S. Pat. No. 6,181,371 issued to Maguire, Jr. on Jan. 30, 2001; U.S. Pat. No. 6,304,267 issued to Sata on Oct. 16, 2001; U.S. Pat. No. 6,351,273 issued to Lemelson et al. on Feb. 26, 2002; U.S. Pat. No. 6,359,603 issued to Zwern on Mar. 19, 2002, and U.S. Pat. No. 6,400,364 issued to Akisada et al. on Jun. 4, 2002.

### BRIEF SUMMARY OF THE INVENTION

The present invention provides a virtual reality display apparatus for generating virtual reality images to be viewed by a user. Also provided is an associated display mounting system for mounting a virtual reality image generating system. The virtual reality display apparatus includes an image generating system for generating virtual reality images. The image generating system includes a first video display unit for displaying video images to one eye of the user, and a second video display unit for displaying video to the other eye of the user, and includes a video drive unit which receives video signals from a control unit and converts the video signal into the format needed to operate the first and second video display units. The image generating system also including a head orientation tracking unit which communicates information to the control unit. In response thereto, the control unit communicates video signals to the image generating system for the generation of video images which are correlated to the orientation of the user's head. The virtual reality display apparatus also includes a display mounting system for being secured on the head of the user and for supporting the image generating system in a position whereby the virtual reality images can be view by the user. The display mounting system includes a frame defining a perimeter for surrounding the eyes of the user, and a gasket secured to the perimeter of the frame for engaging the face of the user. The gasket is fabricated of a resilient material for cushioning the engagement of the display mounting system with the face of the user. Further, the gasket deforms upon engagement with the face of the user to seal the engagement of the display mounting system with the face of the user and such that the transmission of ambient light between the frame and the face of the user is precluded. The display mounting system further including a support panel secured to the frame for supporting the image generating system, and includes a securing strap. The securing strap is fabricated of an elastic material such that as the securing strap is secure about the head of the user, the elastic material of the securing strap pulls the frame toward the face of the user causing the gasket to deform against the face of the user.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a virtual reality display apparatus of the present invention;

FIG. 2 is a side elevation view of a virtual reality display apparatus of the present invention as it is worn by a user;

FIG. 3 is a schematic illustration of the wiring connections between a control unit and the virtual reality display apparatus of the present invention;

FIG. 4 is a schematic illustration of virtual reality image generating system of the virtual reality display apparatus of the present invention;

FIG. 5 is a schematic side elevation view of a virtual reality display apparatus of the present invention;

FIG. 6 is a front elevation view of a mounting panel and virtual reality image generating system of the present invention;

FIG. 7 is a perspective view of certain components of the display mounting system of the present invention;

FIG. 8 is a rear view of the virtual reality display apparatus of the present invention;

FIG. 9A is a perspective view of an alternate embodiment of the virtual reality display apparatus of the present invention; and

FIG. 9B is a perspective view of another alternate embodiment of the virtual reality display apparatus of the present invention.

### DETAILED DESCRIPTION OF THE INVENTION

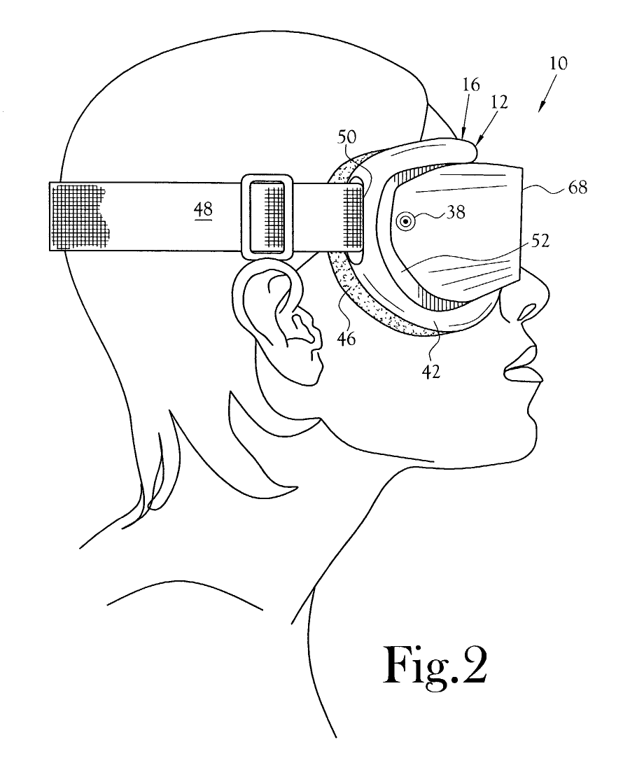

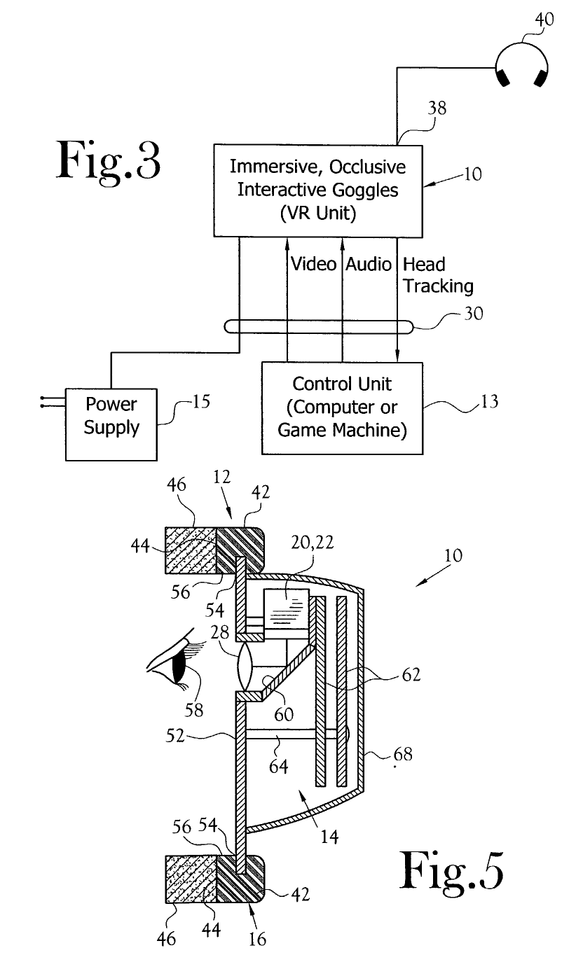

A virtual reality display apparatus in accordance with the present invention is illustrated generally at 10 in the Figures. The virtual reality display apparatus 10 includes display mounting system 12, and an electronic virtual reality image generating system 14 (see FIGS. 3 and 4) which is supported by the mounting system 12 and which displays virtual reality video images to a user. As will be discussed in more detail below, the mounting system 12 includes a housing 16 which, in the preferred illustrated embodiment, defines a goggle-like configuration that is designed to be positioned over the eyes of a user as illustrated in FIG. 2. It will become clear from the discussion which follows that the mounting system 12 allows components of the virtual reality image generating system 14 to be comfortably worn by a user, and minimizes the infiltration of ambient light into the field of view of the user which could degrade the display being generated, or serve as a visual distraction to the user.

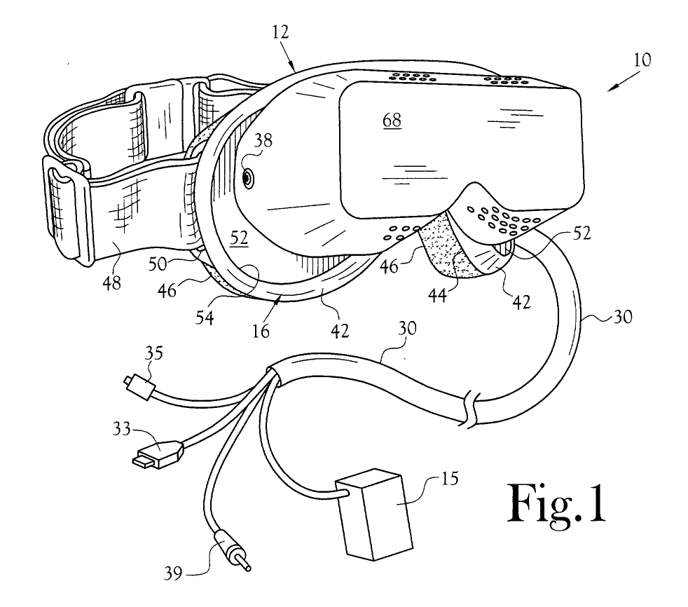

As is schematically illustrated in FIG. 3, the image generating system 14 is designed to communicate with a control unit 13. The control unit 13 provides the video signals necessary to generate the virtual reality images to be displayed to the user of the apparatus 10, and provides audio signals for any accompanying audio to be communicated to the user. It will be understood that the control unit 13 can be a personal or business computer, a game machine, or various other devices for generating video signals, or for generating both video and audio signals. Further, and as will be discussed in more detail below, the virtual reality display apparatus 10 is preferably used in conjunction with a control unit 13 which is capable of receiving data regarding the position or orientation of the user's head, and capable of providing a video feed that generates virtual reality images which vary depending upon head orientation of the user's head. It is also noted that, in the illustrated embodiment of FIG. 1 the display apparatus 10 is connected by cable 30 to a suitable power supply 15. However, it will be understood by those of ordinary skill in the art that power to operate the display apparatus 10 can be obtained via cable from the control unit 13, or from batteries disposed in, or attached to, the housing 16 of the display apparatus 10.

As is schematically illustrated in FIG. 4, the electronic virtual reality image generating system 14 includes a first video display unit 20 for displaying video images to one of the user's eyes, and a second video display unit 22 for displaying video images to the other eye of the user. In the preferred illustrated embodiment each of the video display units 20 and 22 includes a backlight 24 and a light collecting diode array 26 which provides video images to the eye of the user through a magnifying lens 28. It will, of course, be understood by those skilled in the art that other display methods could be used for generating optical images, such as, for example, retinal scanners, LED arrays and micro-mirror arrays. Accordingly, the illustrated video display units 20 and 22 are merely illustrative of one preferred means for generating the desired images.

The image generating system 14 also includes a video drive unit 32 which provides a video buffer and the drive circuitry that receives the incoming video signal from the control unit 18 and converts it into the format needed to operate the video display units 20 and 22. The video buffer can be combined for both displays providing a monoscopic display, or separated into to channels for a stereoscopic display. The video drive unit 32 communicates with the control unit 13 via the cable 30, and, accordingly, the cable 30 is provided with a suitable connector 33 for connecting the cable 30 to the video output of the control unit 13.

The electronic virtual reality image generating system 14 of the apparatus 10 also includes a head orientation tracking unit 34 which communicates information to the control unit 18 regarding the orientation of the user's head such that the appropriate view is generate given the orientation of the user's head. In the preferred embodiment of the apparatus 10, the head orientation tracking unit 32 includes an array of accelerometers, but it will be understood that, alternatively, mercury switches, magnetic coils, or other means, could be used for tracking the orientation of the user's head. Further, a communications interface 36 is provided which converts the head orientation measurements derived by the head orientation tracking unit 34 to data which is communicated to the control unit 13. Preferably, the interface 36 is a USB interface which communicates with the control unit via the cable 30, but other serial communications interfaces can be used including RS232, firewire, etc. Where a USB interface is used, the cable 30 is provided with a suitable USB connector 35 for connecting to a USB port on the control unit 13.

As illustrated in FIGS. 3 and 4, the virtual reality display apparatus 10 is provided with an audio output 38 which communicates with the audio output of the control unit 13 via the cable 30. Accordingly, the cable 30 is provided with an audio connector 39 for connecting to the audio output of the control unit 13. The audio out 38 allows users to select the headphones 40, or other audio monitoring devices, which are used to monitor the audio which accompanies the virtual reality video images being generated. It is, however, contemplated that the apparatus 10 could be provided with speakers housed in, or attached to, the housing 16 such that a separate audio monitoring device is not necessary.

As noted above, the virtual reality display apparatus 10 includes display mounting system 12 having the housing 16 in which the image generating system 14 is mounted. The housing 16 includes a frame 42 which defines a goggle-like shape. In the preferred embodiment the frame 42 is fabricated of an opaque rubber, or similar resilient, flexible material, which allows the frame 42 to bend around the face of a user, and which is substantially impenetrable to light. The frame 42 defines a rear perimeter surface 44 to which is secured a gasket 46. The gasket 46 follows the goggle-like contour of the frame 42, and serves to provide a cushioning interface between the frame and the face of a user, as illustrated in FIG. 2. The gasket 46 also serves to block out light which otherwise might leak into the field of view of the user between the face of the user and the frame 42. In this regard, in the preferred embodiment the gasket 46 is fabricated of a foam, or other soft, resilient material, which deforms with pressure to follow the contours of the face of the user, and which is opaque.

The display mounting system 12 also includes a securing strap 48 which is secured to opposite sides of the housing 16, and which is received around the head of a user (see FIG. 2) to hold the housing 16 firmly in place on the face of the user. In the illustrated embodiment the frame 42 is provided with slots 50 on opposite sides of the frame 42 through which the strap 48 is received to facilitate the securing of the strap 48 to the frame 42. It will, however, be understood that various securing mechanisms could be used to secure the strap 48 to the frame 42. Preferably the securing strap 48 is fabricated of an elastic material such that, as the strap 48 is secure about the head of the user, the elastic material of the strap 48 pulls the frame 42 toward the user's face. This causes the gasket 46 to deform against the surface of the user's face and seal any gaps between the frame 42 and the surface of the user's face.

The housing 16 also includes a support panel 52 which is mounted in the frame 42. In the preferred illustrated embodiment, the support panel 52 defines an outer perimeter which is configured to be releasably, or permanently, received in a mounting slot 54 provided in the interior wall 56 of the frame 42. It will be understood that the flexibility of the frame 42 allows the support panel 52 to readily inserted into the frame 42, and the seating of the perimeter of the support panel 52 in the mounting slot 54 insures that no gaps exist between the frame 42 and the support panel 54 through which light can be transmitted.

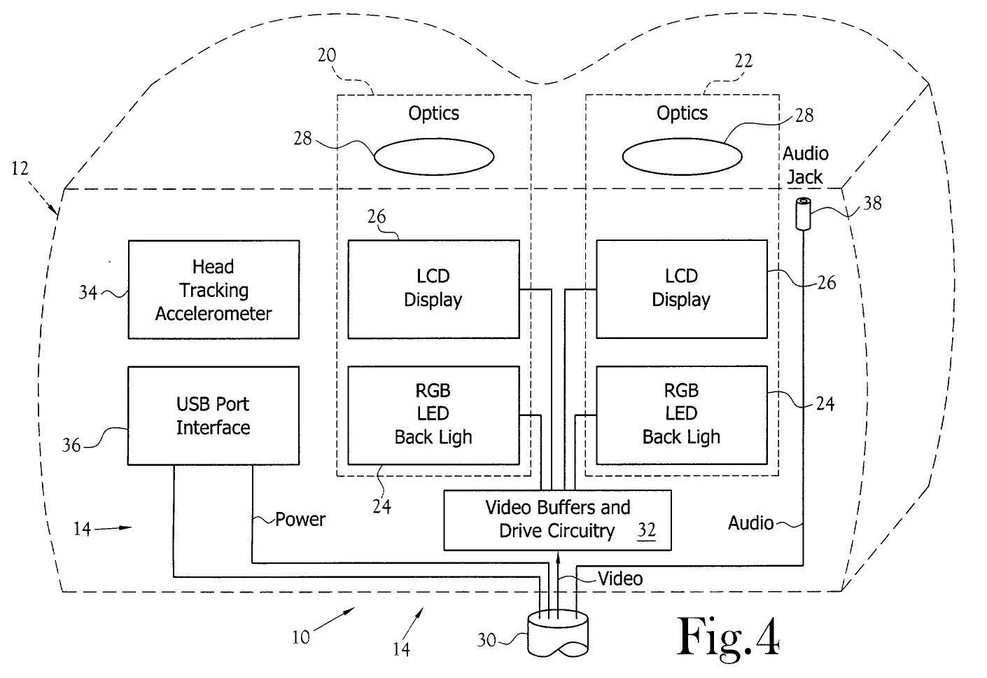

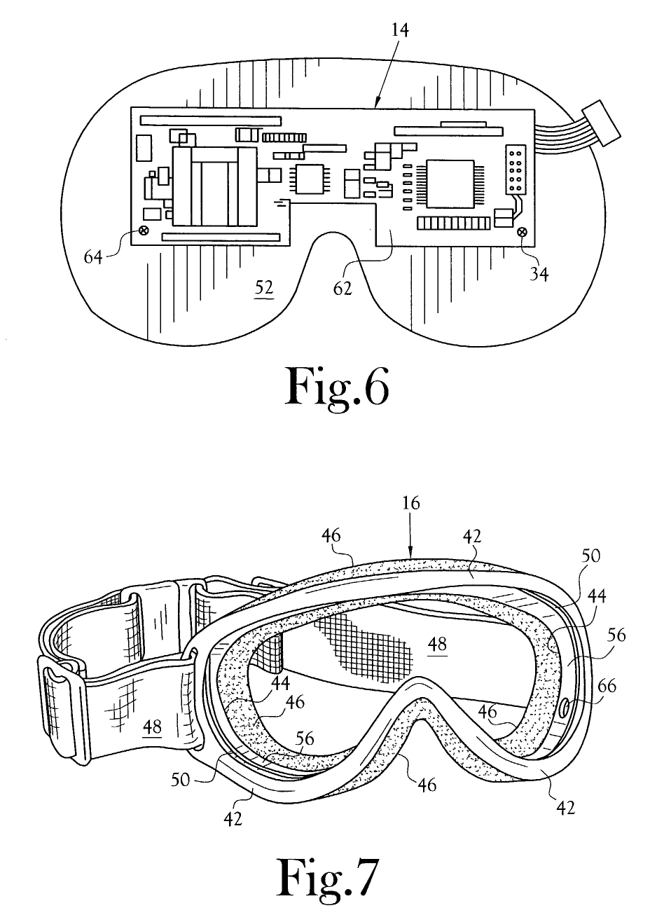

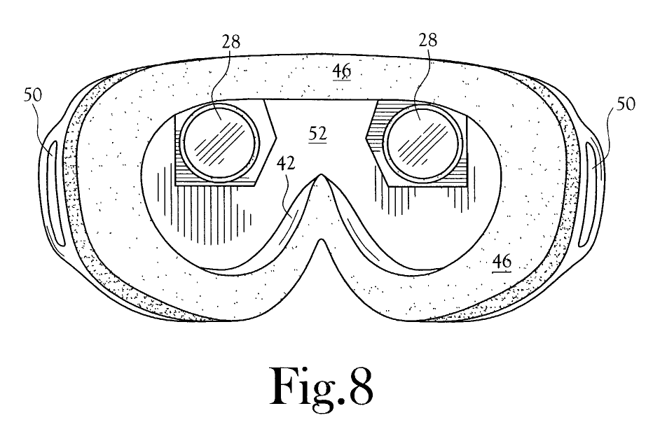

As illustrated in FIGS. 5, 6 and 8, in the preferred embodiment of the apparatus 10, various components of the virtual reality image generating system 14 are mounted on support panel 52. In this regard, as is schematically illustrated in FIG. 5, the lens 28 are mounted in openings in the support panel 52 such that a lens 28 is positioned in front of each eye 58 of the user. The video display units 20 and 22 are mounted on the support panel 52, with the video image which is generated being projected to the lens 28 using a mirror 60, there being a mirror 60 operatively associated with each lens 28. Other components of the virtual reality image generating system 14, including the video drive unit 32, the head orientation tracking unit 34 and the communications interface 36, are mounted on one or more circuit boards 62 secured to the support panel 52 with a mounting column 64. It will also be noted that an opening 66 is provided in the frame 42 for receiving the cable 30. Further, in the preferred embodiment of the virtual reality display apparatus 10 the display mounting system 12 includes a cover 68 which is releasably secured to the support panel 52. As illustrated, the cover 68, in cooperation with the support panel 52, encloses and protects the various components of the image generating system 14.

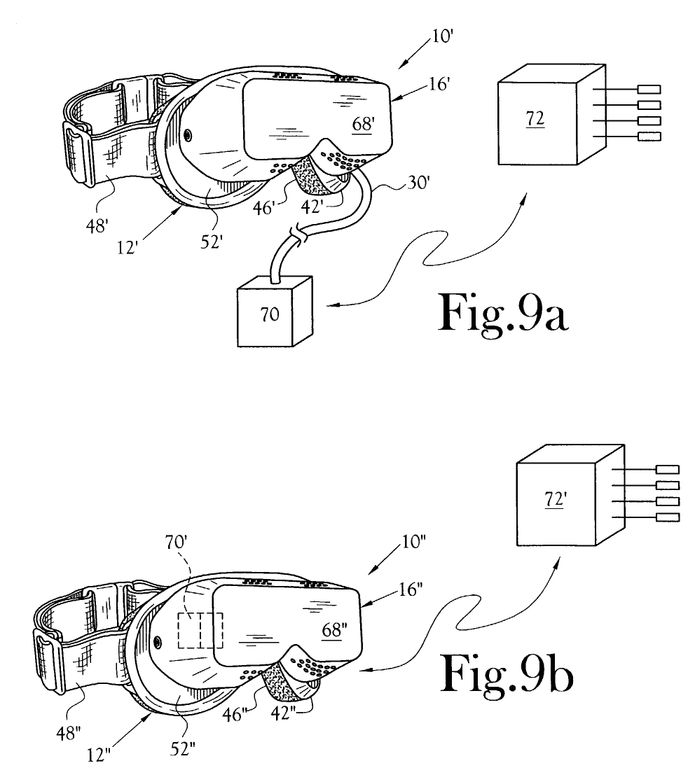

In FIG. 9A an alternate embodiment of the display apparatus of the present invention is illustrated generally at 10′, and in FIG. 9B a further alternate embodiment of the display apparatus of the present invention is illustrated generally at 10″. The apparatus 10′ is provided with a first transceiver 70, which wirelessly communicates with a second transceiver 72 that is connected to the control unit 13. It will be recognized by those skilled in the art that the transceivers 70 and 72 allow video and audio signals, and head orientation tracking signals, to be remotely communicated between the apparatus 10′ and the control unit 13 such a user's movement is not restricted by the use of a cable between the apparatus 10′ and the control unit 13. It is contemplated that the tranceiver 70 can be encased in a housing which releasably secures to a user's belt, or which is otherwise secured to the user. It is also contemplated that the housing can enclose a suitable power supply for both the apparatus 10′ and the transceiver 70. The apparatus 10″ of FIG. 9B, is provide with transceivers 70′ and 72′ which allow wireless communication between the apparatus 10″ and the control unit 13. However, in the apparatus 10″ the transceiver 70′ is positioned within the housing 16″.

In light of the above it will be recognized that the virtual reality display apparatus of the present invention offers great advantages over the prior art. The display mounting system 12 allows the image generating system 14 to be firmly affixed to the head of the user so that the display will not move relative to the head when the head moves quickly, and allows the system to be comfortably worn by a user for extended periods of time. In this regard, the gasket 46 cushions the engagement of the mounting system 12 with the face of the user, and serves to spread the pressure applied by the securing strap 48, and the weight of the apparatus 10, over a wider area of the head of the user. Further, the frame 42, gasket 46, and support panel 52, cooperatively occlude substantially all ambient light which could degrade the virtual reality images being displayed by the image generating system 14, or which could distract the user during operation of the apparatus 10. Accordingly, the virtual reality display apparatus 10 of the present invention enhances the overall virtual reality experience.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A virtual reality display apparatus for generating virtual reality images to be viewed by a user, said virtual reality display apparatus comprising:
an image generating system for generating the virtual reality images; and
a display mounting system for being secured on the head of the user and for supporting said image generating system in a position whereby the virtual reality images can be view by the user, said display mounting system including a frame defining a perimeter for surrounding the eyes of the user, and a gasket secured to said perimeter of said frame for engaging the face of the user, said gasket be fabricated of a resilient material for cushioning the engagement of said display mounting system with the face of the user, and whereby said gasket deforms upon engagement with the face of the user to seal the engagement of said display mounting system with the face of the user and substantially occludes the transmission of ambient light between said frame and the face of the user, said display mounting system further including a support member secured to said frame for supporting said image generating system proximate the eyes of the user.

2. The virtual reality display apparatus of claim 1 wherein said gasket is fabricated of a foam material.

3. The virtual reality display apparatus of claim 1 wherein said frame defines a goggle-like configuration.

4. The virtual reality display apparatus of claim 1 wherein said support member defines a support panel having a perimeter which is closely received in said frame, whereby the transmission of ambient light between said frame and said support panel is substantially prohibited.

5. The virtual reality display apparatus of claim 1 wherein said display mounting system includes a securing strap secured to said frame for being releasably received about the head of the user, whereby said frame is secured in position on the head of the user.

6. The virtual reality display apparatus of claim 5 wherein said securing strap is fabricated of an elastic material such that as said securing strap is secure about the head of the user, said elastic material of said securing strap pulls said frame toward the face of the user causing said gasket to deform against the surface of the face of the user, whereby any gaps between said frame and the surface of the face of the user are sealed by said gasket.

7. The virtual reality display apparatus of claim 1 wherein said image generating system includes a first video display unit for displaying video images to one eye of the user, and a second video display unit for displaying video to the other eye of the user, and includes a video drive unit which receives video signals from a control unit and converts the video signals into the format needed to operate said first and second video display units.

8. The virtual reality display apparatus of claim 6 wherein said image generating system includes a first video display unit for displaying video images to one eye of the user, and a second video display unit for displaying video to the other eye of the user, and includes a video drive unit which receives video signals from a control unit and converts the video signals into the format needed to operate said first and second video display units.

9. The virtual reality display apparatus of claim 8 wherein said image generating system includes a head orientation tracking unit which communicates information to the control unit, whereby the control unit communicates video signals to said video drive unit for the generation of video images which are correlated to the orientation of the user's head.

10. The virtual reality display apparatus of claim 9 wherein each said first and second video display unit includes a backlight and a light collecting diode array, and further includes a magnifying lens through which video images are projected to the eye of the user.

11. The virtual reality display apparatus of claim 6 wherein said display mounting system includes a cover for releasably enclosing said image generating system.

12. A display mounting system for supporting an image generating system for generating virtual reality images and for releasably mounting the image generating system on the head of a user, said display mounting system comprising a frame defining a perimeter for surrounding the eyes of the user, and a gasket secured to said perimeter of said frame for engaging the face of the user, said gasket be fabricated of a resilient material for cushioning the engagement of said display mounting system with the face of the user, and whereby said gasket deforms upon engagement with the face of the user to seal the engagement of said display mounting system with the face of the user and substantially occludes the transmission of ambient light between said frame and the face of the user, said display mounting system further including a support member secured to said frame for supporting the image generating system.

13. The display mounting system of claim 12 wherein said gasket is fabricated of a foam material.

14. The display mounting system of claim 12 wherein said frame defines a goggle-like configuration.

15. The display mounting system of claim 12 wherein said support member defines a support panel having a perimeter which is closely received in said frame, whereby the transmission of ambient light between said frame and said support panel is substantially prohibited.

16. The display mounting system of claim 12 wherein said display mounting system includes a securing strap secured to said frame and for being releasably received about the head of the user, whereby said frame is secured in position on the head of the user.

17. The display mounting system of claim 16 wherein said securing strap is fabricated of an elastic material such that as said securing strap is secure about the head of the user, said elastic material of said securing strap pulls said frame toward the face of the user causing said gasket to deform against the surface of the face of the user, whereby any gaps between said frame and the surface of the face of the user are sealed by said gasket.

18. The display mounting system of claim 17 wherein said frame is fabricated of a rubber material.

19. A virtual reality display apparatus for generating virtual reality images to be viewed by a user, said virtual reality display apparatus comprising:
an image generating system for generating the virtual reality images, said image generating system including a first video display unit for displaying video images to one eye of the user, and a second video display unit for displaying video images to the other eye of the user, and includes a video drive unit which receives video signals from a control unit and converts the video signals into the format needed to operate said first and second video display units, said image generating system also including a head orientation tracking unit which communicates information to the control unit regarding the orientation of the user's head, whereby the control unit communicates video signals to said video drive unit for the generation of video images which are correlated to the orientation of the user's head; and
a display mounting system for being secured on the head of the user and for supporting said image generating system in a position whereby the virtual reality images can be view by the user, said display mounting system including a frame defining a perimeter for surrounding the eyes of the user, and a gasket secured to said perimeter of said frame for engaging the face of the user, said gasket be fabricated of a resilient material for cushioning the engagement of said display mounting system with the face of the user, and whereby said gasket deforms upon engagement with the face of the user to seal the engagement of said display mounting system with the face of the user and substantially occludes the transmission of ambient light between said frame and the face of the user, said display mounting system further including a support member secured to said frame for supporting said image generating system; said display mounting system also including a securing strap fabricated of an elastic material such that as said securing strap is secure about the head of the user, said elastic material of said securing strap pulls said frame toward the face of the user causing said gasket to deform against the surface of the face of the user.
